(19) United States
(12) Patent Application Publication
(10) Pub. No.: US 2026/0334548 A1
(43) Pub. Date: Oct. 29, 2026

(54) HEATER AND AEROSOL GENERATING DEVICE COMPRISING THE SAME

(71) Applicant: SHENZHEN FIRST UNION TECHNOLOGY CO., LTD., Shenzhen, Guangdong (CN)

(72) Inventors: Zhiming Lu, Shenzhen, Guangdong (CN); Wei Chen, Shenzhen, Guangdong (CN); Ruilong Hu, Shenzhen, Guangdong (CN); Zhongli Xu, Shenzhen, Guangdong (CN); Yonghai Li, Shenzhen, Guangdong (CN)

(73) Assignee: SHENZHEN FIRST UNION TECHNOLOGY CO., LTD., Shenzhen, Guangdong (CN)

(21) Appl. No.: 18/995,244

(22) PCT Filed: Jul. 5, 2023
(86) PCT No.: PCT/CN2023/105867

§ 371 Date: Jan. 16, 2025

(30) Foreign Application Priority Data
Jul. 21, 2022 (CN) 202210862107.1

(51) Int. Cl. A24F 40/46; H05B 3/40

(52) U.S. Cl. CPC A24F 40/46; H05B 3/40; H05B 2203/013; H05B 2203/032

(57) ABSTRACT

A heater and an aerosol generating device are provided. The heater includes: a base body; an infrared electrothermal coating; and a conductive element which includes a first conductive electrode, a second conductive electrode, and at least one connecting electrode. The connecting electrode is configured to divide the infrared electrothermal coating into at least two infrared electrothermal sub-coatings connected in series between the first conductive electrode and the second conductive electrode. The first conductive electrode is configured to receive an inflow of an external current, the inflow current sequentially passes through the at least two infrared electrothermal sub-coatings connected in series and then flows out from the second conductive electrode, and the infrared electrothermal sub-coatings start heating an aerosol-forming substrate simultaneously.

### CROSS-REFERENCE TO RELATED APPLICATIONS

This application claims priority to earlier Patent Application No. 202210862107.1, entitled “HEATER AND AEROSOL GENERATING DEVICE INCLUDING SAME” and filed with the China National Intellectual Property Administration on Jul. 21, 2022, which is incorporated herein by reference in its entirety.

### TECHNICAL FIELD

This application relates to the field of electronic atomization technologies, and in particular, to a heater and an aerosol generating device including the heater.

### BACKGROUND

In an existing aerosol generating device, a far-infrared coating and a conductive coating are mainly coated on an outer surface of a base body, and after the aerosol generating device is powered on, the far-infrared coating emits a far-infrared ray to penetrate the base body and heats an aerosol-forming substrate in the base body. The far-infrared ray has strong penetrability and can penetrate a periphery of the aerosol-forming substrate and enter the interior, so that heating to the aerosol-forming substrate is uniform.

Problems existing in the aerosol generating device are that, the far-infrared coating has a large resistance value, leading to long preheating time of the aerosol-forming substrate, affecting inhalation experience of a user.

### SUMMARY

This application provides a heater and an aerosol generating device including the heater, and aims to resolve the problem of a large resistance value of a far-infrared coating in existing aerosol generating devices.

According to an aspect of this application, a heater is provided, including:
a base body;
an infrared electrothermal coating, arranged on a surface of the base body, where the infrared electrothermal coating is configured to generate an infrared ray radiantly heating an aerosol-forming substrate after the heater is powered on; and
a conductive element, including a first conductive electrode, a second conductive electrode, and at least one connecting electrode that are arranged at intervals on the surface of the base body, where
the at least one connecting electrode is configured to divide the infrared electrothermal coating into at least two infrared electrothermal sub-coatings connected in series between the first conductive electrode and the second conductive electrode; and
one of the first conductive electrode and the second conductive electrode is configured to receive an inflow of an external current, and the inflow current sequentially passes through the at least two infrared electrothermal sub-coatings connected in series and then flows out from the other of the first conductive electrode and the second conductive electrode.

According to another aspect of this application, an aerosol generating device is provided, including a power supply configured to supply power and the heater described above.

According to the heater and the aerosol generating device including the heater provided in this application, the connecting electrode divides the infrared electrothermal coating into at least two infrared electrothermal sub-coatings connected in series between the first conductive electrode and the second conductive electrode, and the infrared electrothermal sub-coatings connected in series start heating the aerosol-forming substrate simultaneously. In this way, the problem of a large resistance value of a far-infrared coating is avoided, and inhalation experience of a user is improved.

### BRIEF DESCRIPTION OF THE DRAWINGS

One or more embodiments are exemplarily described with reference to the corresponding figures in the accompanying drawings, and the description does not constitute a limitation to the embodiments. Elements in the accompanying drawings that have same reference numerals are represented as similar elements, and unless otherwise particularly stated, the figures in the accompanying drawings are not drawn to scale.

FIG. 1 is a schematic diagram of an aerosol generating device according to an implementation of this application;

FIG. 2 is a schematic exploded view of an aerosol generating device according to an implementation of this application;

FIG. 3 is a schematic diagram of a first heater according to an implementation of this application;

FIG. 4 is a schematic diagram of an unfolded infrared electrothermal coating in a first heater according to an implementation of this application;

FIG. 5 is a schematic diagram of a connecting electrode according to an implementation of this application;

FIG. 6 is a schematic diagram of a second heater according to an implementation of this application;

FIG. 7 is a schematic diagram of a third heater according to an implementation of this application;

FIG. 8 is a schematic diagram of a fourth heater according to an implementation of this application;

FIG. 9 is a schematic diagram of a fifth heater according to an implementation of this application;

FIG. 10 is a schematic diagram of an unfolded infrared electrothermal coating in a fifth heater according to an implementation of this application;

FIG. 11 is a schematic diagram of a sixth heater according to an implementation of this application; and

FIG. 12 is a schematic diagram of an unfolded infrared electrothermal coating in a sixth heater according to an implementation of this application.

### DETAILED DESCRIPTION

For ease of understanding of this application, this application is described below in more detail with reference to the accompanying drawings and specific implementations. It should be noted that, when an element is expressed as “being fixed to” another element, the element may be directly on the another element, or one or more intermediate elements may exist between the element and the another element. When an element is expressed as “being connected to” another element, the element may be directly connected to the another element, or one or more intermediate elements may exist between the element and the another element. The terms “upper”, “lower”, “left”, “right”, “inner”, “outer”, and similar expressions used in this specification are merely used for an illustrative purpose.

Unless otherwise defined, meanings of all technical and scientific terms used in this specification are the same as those usually understood by a person skilled in the technical field to which this application belongs. The terms used in this specification of this application are merely for the purpose of describing the specific implementations, and are not intended to limit this application. The term “and/or” used in this specification includes any and all combinations of one or more related listed items.

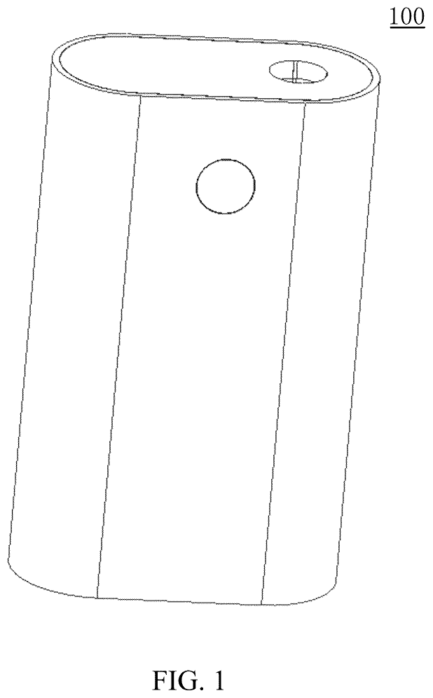

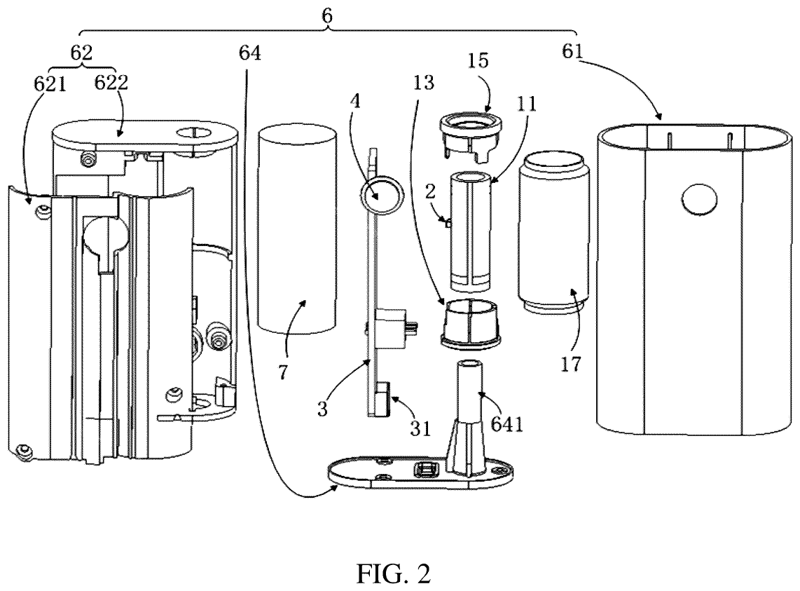

FIG. 1 and FIG. 2 are an aerosol generating device 100 according to an implementation of this application, which includes a housing assembly 6 and a heater 11. The heater 11 is arranged in the housing assembly 6. The heater 11 can radiate an infrared ray to heat an aerosol-forming substrate, to generate inhalable aerosols.

The housing assembly 6 includes an outer housing 61, a fixing housing 62, a base, and a bottom cover 64, where the fixing housing 62 and the base are fixed in the outer housing 61, the base is configured to fix the heater 11, the base is arranged in the fixing housing 62, and the bottom cover 64 is arranged at an end of the outer housing 61 and covers the outer housing 61. An insertion port is provided on the fixing housing 62, and the aerosol-forming substrate is removably received or inserted in the heater 11 through the insertion port.

The base includes a base 15 sleeved on an upper end of the heater 11 and a base 13 sleeved on a lower end of the heater 11, and the base 15 and the base 13 are arranged in the fixing housing 62. An air inlet tube 641 is convexly provided on the bottom cover 64, one end of the base 13 facing away from the base 15 is connected to the air inlet tube 641, the base 15, the heater 11, the base 13, and the air inlet tube 641 are coaxially arranged, the heater 11 is sealed with the base 15 and the base 13 through sealing members, the base 13 and the air inlet tube 641 are also sealed, and the air inlet tube 641 is in communication with external air, so that smooth air intake can be implemented during inhalation by a user.

The aerosol generating device 100 further includes a circuit board 3 and a battery core 7. The fixing housing 62 includes a front housing 621 and a rear housing 622, the front housing 621 is fixedly connected to the rear housing 622, the circuit board 3 and the battery core 7 are arranged in the fixing housing 62, the battery core 7 is electrically connected to the circuit board 3, a key 4 is convexly arranged on the outer housing 61, and the heater 11 can be powered on or off by pressing the key 4. The circuit board 3 is further connected to a charging interface 31, the charging interface 31 is exposed on the bottom cover 64, and the user may charge or upgrade the aerosol generating device 100 through the charging interface 31, to ensure continuous use of the aerosol generating device 100.

The aerosol generating device 100 further includes a heat insulation tube 17, the heat insulation tube 17 is arranged in the fixing housing 62, the heat insulation tube 17 is arranged at a periphery of the heater 11, and the heat insulation tube 17 can prevent a large amount of heat from being transferred to the outer housing 61 and causing the user to feel burnt. The heat insulation tube includes a heat insulation material, and the heat insulation material may be heat insulation glue, aerogel, aerogel felt, asbestos, aluminum silicate, calcium silicate, diatomite, or zirconium oxide. The heat insulation tube may alternatively be a vacuum heat insulation tube. An infrared ray reflective coating may be further formed in the heat insulation tube 17, to reflect the infrared ray radiated by the heater 11 to the aerosol-forming substrate, thereby improving heating efficiency.

The aerosol generating device 100 further includes a temperature sensor 2, for example, an NTC temperature sensor, to detect a real-time temperature of the heater 11, and transmit the detected real-time temperature to the circuit board 3, and the circuit board 3 adjusts a magnitude of a current flowing through the heater 11 according to the real-time temperature. Specifically,

when the NTC temperature sensor detects that the real-time temperature of the heater 11 is low, for example, detects that the temperature of the heater 11 does not reach 150 °C, the circuit board 3 controls the battery core 7 to output a high voltage to a conductive element, to further increase a current fed into the heater 11, improve heating power to the aerosol-forming substrate, and reduce time for which the user needs to wait before inhalation is performed.

When the NTC temperature sensor detects that the temperature of the heater 11 ranges from 150 °C to 200 °C, the circuit board 3 controls the battery core 7 to output a normal voltage to the heater 11.

When the NTC temperature sensor detects that the temperature of the heater 11 ranges from 200 °C to 250 °C, the circuit board 3 controls the battery core 7 to output a low voltage to the heater 11.

When the NTC temperature sensor detects that the temperature of the heater 11 is 250 °C or higher, the circuit board 3 controls the battery core 7 to stop outputting a voltage to the heater 11.

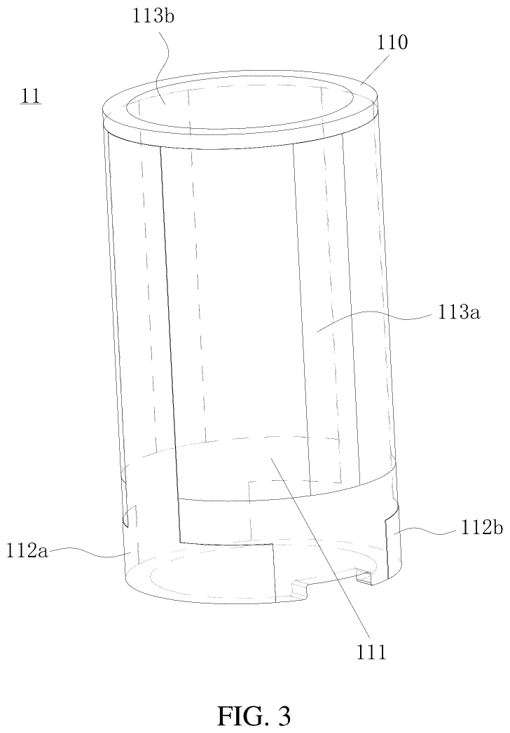

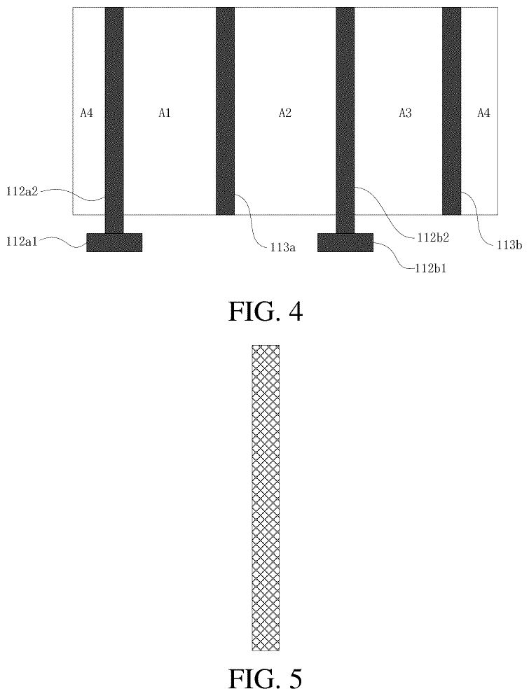

FIG. 3 and FIG. 4 are a first heater according to an implementation of this application. The heater 11 includes a base body 110, an infrared electrothermal coating 111, and a conductive element.

The base body 110 may be made of a high-temperature-resistant and transparent material such as silica glass, ceramic, or mica, or may be made of another material with a high infrared ray transmittance, for example, a high-temperature-resistant material with an infrared ray transmittance of 95% or higher. This is not specifically limited herein.

The base body 110 is approximately in a shape of a tube, and preferably, a shape of a round tube. A hollow portion in the base body 110 defines or forms a chamber receiving the aerosol-forming substrate. An inner diameter of the base body 110 ranges from 7 mm to 14 mm, or ranges from 7 mm to 12 mm, or ranges from 7 mm to 10 mm.

The aerosol-forming substrate is a substrate that can release volatile compounds forming aerosols. The volatile compounds may be released by heating the aerosol-forming substrate. The aerosol-forming substrate may be solid, liquid, or include solid and liquid components. The aerosol-forming substrate may be carried on a carrier or a support through absorption, coating, impregnation, or other manners. The aerosol-forming substrate may conveniently be a part of an aerosol generating article.

The aerosol-forming substrate may include nicotine. The aerosol-forming substrate may include tobaccos, for example, may include a tobacco-contained material including volatile tobacco-flavor compounds, and the volatile tobacco-flavor compounds are released from the aerosol-forming substrate when the aerosol-forming substrate is heated. The aerosol-forming substrate may include at least one aerosol forming agent, and the aerosol forming agent may be any suitable known compound or a mixture of compounds. During use, the compound or the mixture of compounds facilitates formation of dense and stable aerosols and is basically resistant to thermal decomposition under an operating temperature of an aerosol generating system. A suitable aerosol forming agent is well known in the art, which includes, but not limited to: polyol, such as triethylene glycol, 1,3-butanediol, and glycerin; polyol ester, such as monoglyceride and diacetate or triacetate; and monobasic carboxylic acid, dibasic carboxylic acid, and polybasic carboxylic acid fatty acid ester, such as dimethyl dodecane dibasic ester and dimethyl tetradecane dibasic ester.

An infrared electrothermal coating 111 is formed on a surface of the base body 110. The infrared electrothermal coating 111 may be formed on an outer surface of the base body 110, or may be formed on an inner surface of the base body 110. Preferably, the infrared electrothermal coating 111 is formed on the outer surface of the base body 110. An extension length of the infrared electrothermal coating 111 in an axial direction of the base body 110 ranges from 5 mm to 40 mm; or ranges from 5 mm to 30 mm; or ranges from 5 mm to 20 mm; or ranges from 10 mm to 20 mm.

The infrared electrothermal coating 111 receives electrical power and generates heat, to radiate an infrared ray having a specific wavelength, for example, a far-infrared ray whose wavelength ranges from 8 μm to 15 μm. When the wavelength of the infrared ray matches an absorption wavelength of the aerosol-forming substrate, energy of the infrared ray can be easily absorbed by the aerosol-forming substrate.

In this example, the wavelength of the infrared ray is not limited, and the infrared ray may be an infrared ray whose wavelength ranges from 0.75 μm to 1000 μm, and preferably, a far-infrared ray whose wavelength ranges from 1.5 μm to 400 μm.

The infrared electrothermal coating 111 is spaced apart from an upper end of the base body 110, and a spacing distance ranges from 0.2 mm to 1 mm, which is conducive to manufacturing and production. The infrared electrothermal coating 111 is also spaced apart from a lower end of the base body 110, and a spacing distance ranges from 1 mm to 4 mm, which is conducive to arrangement of a conductive electrode and also prevents a temperature of the lower end of the base body 110 from being excessively high. It should be noted that, viewing from a flow direction of the aerosols, the upper end of the base body 110 is located downstream of the lower end of the base body 110.

A conductive element includes a conductive electrode 112a, a conductive electrode 112b, a connecting electrode 113a, and a connecting electrode 113b that are arranged at intervals on the surface of the base body 110. That being arranged at intervals refers to that any two of the electrodes are not in direct contact to form a short circuit.

The conductive electrode 112a includes a coupling portion 112a1 extending in a circumferential direction of the base body 110 and a conductive portion 112a2 extending in an axial direction from the coupling portion 112a1 toward the upper end of the base body 110. The coupling portion 112a1 is arc-shaped, the coupling portion 112a1 is spaced apart from the infrared electrothermal coating 111, and the coupling portion 112a1 is arranged between the infrared electrothermal coating 111 and the lower end of the base body 110; and a wire may be welded on the coupling portion 112a1, to form an electrical connection with a power supply outside the heater 11, for example, the battery core 7 or a voltage converted by the battery core 7, or to form an electrical connection with the power supply through another electrical connector. The conductive portion 112a2 is strip-shaped, and an extension length of the conductive portion in the axial direction is greater than an extension length of the infrared electrothermal coating 111 in the axial direction; and the conductive portion 112a2 remains in contact with the infrared electrothermal coating 111 to form an electrical connection. A structure of the conductive electrode 112b is similar to the structure of the conductive electrode 112a, and the conductive electrode 112b and the conductive electrode 112a are symmetrically arranged on the base body 110.

It can be seen from FIG. 3 that, the conductive portion 112a2 and the conductive portion 112b2 divide the infrared electrothermal coating 111 into a left half part and a right half part. The connecting electrode 113a is arranged in the right halt infrared electrothermal coating 111, and the connecting electrode 113b is arranged in the left half infrared electrothermal coating 111. The left half infrared electrothermal coating 111 and the right half infrared electrothermal coating 111 are connected in parallel between the conductive portion 112a2 and the conductive portion 112b2.

The connecting electrode 113a is strip-shaped, and an extension length of the connecting electrode in the axial direction is the same as an extension length of the right half infrared electrothermal coating 111 in the axial direction. The connecting electrode 113a divides the right half infrared electrothermal coating 111 into two infrared electrothermal sub-coatings (as shown by A1 and A2 in FIG. 4) connected in series between the conductive portion 112a2 and the conductive portion 112b2, and the infrared electrothermal sub-coating A1 and the infrared electrothermal sub-coating A2 are distributed in the circumferential direction of the base body 110; and an equivalent resistance of the infrared electrothermal sub-coating A1 and an equivalent resistance of the infrared electrothermal sub-coating A2 may be the same or may be different. Through the arrangement of the connecting electrode 113a, an overall resistance of the right half infrared electrothermal coating 111 may be reduced. For example, by arranging one connecting electrode 113a between the conductive portion 112a2 and the conductive portion 112b2, the overall resistance of the right half infrared electrothermal coating 111 may be reduced by about 20%.

It should be noted that, a plurality of connecting electrodes 113a may be arranged in the right half infrared electrothermal coating 111 as required, to divide the right half infrared electrothermal coating 111 into a plurality of infrared electrothermal sub-coatings connected in series between the conductive portion 112a2 and the conductive portion 112b2. For example, two connecting electrodes 113a divide the right half infrared electrothermal coating into three infrared electrothermal sub-coatings connected in series between the conductive portion 112a2 and the conductive portion 112b2, and equivalent resistances of the three infrared electrothermal sub-coatings may be the same or different, or equivalent resistances of two of the infrared electrothermal sub-coatings are the same.

The connecting electrode 113b is similar to the connecting electrode 113a, and for infrared electrothermal sub-coatings obtained through division, reference may be made to A3 and A4 shown in FIG. 4.

After the heater 11 is powered on, for example, the coupling portion 112a1 is electrically connected to a positive electrode of a power supply, the coupling portion 112b1 is electrically connected to a negative electrode of the power supply (or vice versa), and a current flows in from the conductive portion 112a2, flows through the infrared electrothermal sub-coating A1 and the infrared electrothermal sub-coating A2 sequentially or flows through the infrared electrothermal sub-coating A3 and the infrared electrothermal sub-coating A4 sequentially, and then flows out from the conductive portion 112b2. The connecting electrode 113a and the connecting electrode 113b are not connected to a power supply or a circuit outside the heater 11. That is, the connecting electrode 113a and the connecting electrode 113b are suspended, and the current cannot directly flow in from the connecting electrode 113a and then flow out from the conductive portion 112b2 or the conductive portion 112a2.

The conductive electrode 112a, the conductive electrode 112b, the connecting electrode 113a, and the connecting electrode 113b are preferably consecutive conductive coatings. The conductive coating may be a metal coating, and the metal coating may include silver, gold, palladium, platinum, copper, nickel, molybdenum, tungsten, niobium, or alloy materials of the foregoing metals. A width of each of the connecting electrode 113a and the connecting electrode 113b ranges from 0.5 mm to 3 mm; or ranges from 0.5 mm to 2.5 mm. In a specific example, the width may be 1 mm or 2 mm.

In other examples, the connecting electrode 113a and/or the connecting electrode 113b may alternatively be non-consecutive conductive coatings, for example, a conductive coating with meshes shown in FIG. 5.

It should be noted that, during preparation of the heater 11, the connecting electrode 113a and/or the connecting electrode 113b may be arranged between the base body 110 and the infrared electrothermal coating 111 in a direction perpendicular to the surface of the base body 110; or the infrared electrothermal coating 111 may be arranged between the base body 110 and the connecting electrode.

It should be noted that, different from the foregoing example, in other examples, at least one of the conductive electrode 112a, the conductive electrode 112b, the connecting electrode 113a, and the connecting electrode 113b may be attached to the infrared electrothermal coating 111. For example, at least one of the conductive electrode 112a, the conductive electrode 112b, the connecting electrode 113a, and the connecting electrode 113b may be coated on an inner wall of a sleeve, to sleeve the sleeve on the base body 110, so that the at least one of the conductive electrode 112a, the conductive electrode 112b, the connecting electrode 113a, and the connecting electrode 113b is closely attached to the infrared electrothermal coating 111. For the arrangement of the conductive electrode 112a, the conductive electrode 112b, the connecting electrode 113a, and the connecting electrode 113b, reference may be made to the foregoing example.

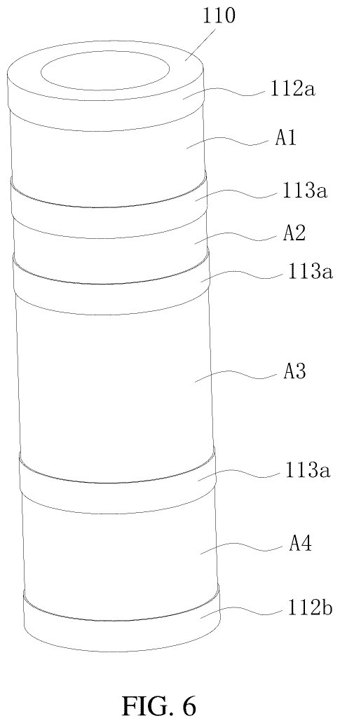

FIG. 6 shows a second heater according to an implementation of this application.

Different from FIG. 3 and FIG. 4, the conductive electrode 112a and the conductive electrode 112b are annular and extend in the circumferential direction of the base body 110; a plurality of connecting electrodes 113a are arranged between the conductive electrode 112a and the conductive electrode 112b, and the connecting electrodes 113a are also annular; and the plurality of connecting electrodes 113a divide the infrared electrothermal coating 111 into four infrared electrothermal sub-coatings (as shown by A1, A2, A3, and A4 in the figure) connected in series between the conductive portion 112a2 and the conductive portion 112b2. Equivalent resistances of the four infrared electrothermal sub-coatings are different. In this way, the overall resistance of the infrared electrothermal coating 111 is reduced, and the uniformity of a temperature field of the base body 110 may be improved.

In this example, the four infrared electrothermal sub-coatings are distributed in the axial direction of the base body 110, and an extension length of the connecting electrode 113a in the circumferential direction of the base body 110 is the same as an extension length of the infrared electrothermal coating 111 in the circumferential direction of the base body 110.

It should be noted that, in other examples, an arc-shaped connecting electrode 113a is also feasible.

After the heater 11 is powered on, for example, the conductive electrode 112a is electrically connected to a positive electrode of a power supply, the conductive electrode 112b is electrically connected to a negative electrode of the power supply, and a current flows in from the conductive electrode 112a, flows through the infrared electrothermal sub-coating A1, the infrared electrothermal sub-coating A2, the infrared electrothermal sub-coating A3, and the infrared electrothermal sub-coating A4 sequentially, and then flows out from the conductive electrode 112b.

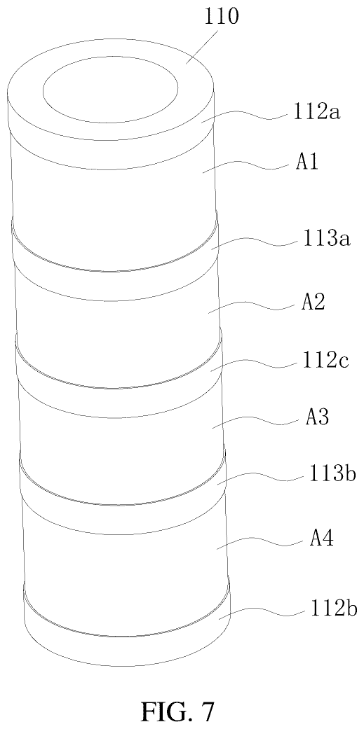

FIG. 7 shows a third heater according to an implementation of this application.

Different from FIG. 6, the conductive element includes a conductive electrode 112c arranged at intervals with other conductive electrodes and connecting electrodes. The conductive electrode 112a, the conductive electrode 112b, and the conductive electrode 112c divide the infrared electrothermal coating 111 into upper and lower independent heating regions. By controlling the two independent heating regions to start heating, the aerosol-forming substrate may be heated in a segmented manner. For example, the upper half heating region is started first to heat a corresponding upper half part of an article; and the lower half heating region is then started to heat a corresponding lower part of the article. Alternatively, the upper half heating region is started first to heat the corresponding upper half part of the article; and the entire heating region is then started to heat the entire article.

The connecting electrode 113a is arranged between the conductive electrode 112a and the conductive electrode 112c, and the connecting electrode 113a divides the upper half heating region into two infrared electrothermal sub-coatings (as shown by A1 and A2 in the figure) connected in series between the conductive electrode 112a and the conductive electrode 112c.

The connecting electrode 113b is arranged between the conductive electrode 112c and the conductive electrode 112b, and the connecting electrode 113b divides the lower half heating region into two infrared electrothermal sub-coatings (as shown by A3 and A4 in the figure) connected in series between the conductive electrode 112c and the conductive electrode 112b.

When the upper half heating region is started, for example, the conductive electrode 112a is electrically connected to a positive electrode of a power supply, the conductive electrode 112c is electrically connected to a negative electrode of the power supply, and a current flows in from the conductive electrode 112a, flows through the infrared electrothermal sub-coating A1 and the infrared electrothermal sub-coating A2 sequentially, and then flows out from the conductive electrode 112c.

When the lower half heating region is started, for example, the conductive electrode 112c is electrically connected to a positive electrode of a power supply, the conductive electrode 112b is electrically connected to a negative electrode of the power supply, and a current flows in from the conductive electrode 112c, flows through the infrared electrothermal sub-coating A3 and the infrared electrothermal sub-coating A4 sequentially, and flows out from the conductive electrode 112b.

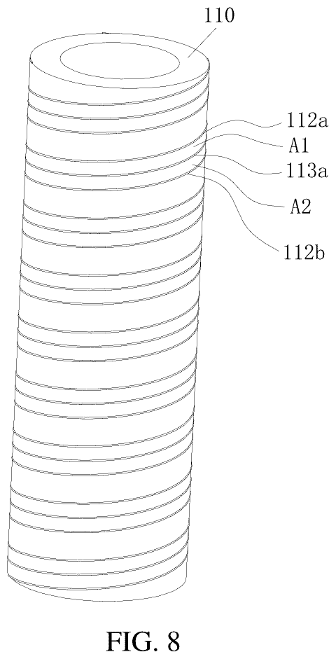

FIG. 8 shows a fourth heater according to an implementation of this application.

Different from FIG. 3 and FIG. 4, the conductive electrode 112a and the conductive electrode 112b spirally extend in the axial direction of the base body 110; one connecting electrode 113a is arranged between the conductive electrode 112a and the conductive electrode 112b, the connecting electrode 113a also spirally extends in the axial direction of the base body 110, and a spiral extending height of the connecting electrode is the same as an extension length of the infrared electrothermal coating 111 in the axial direction of the base body 110; and the connecting electrode 113a divides the infrared electrothermal coating 111 into two infrared electrothermal sub-coatings (as shown by A1 and A2 in the figure) connected in series between the conductive electrode 112a and the conductive electrode 112b.

After the heater 11 is powered on, for example, the conductive electrode 112a is electrically connected to a positive electrode of a power supply, the conductive electrode 112b is electrically connected to a negative electrode of the power supply, and a current flows in from the conductive electrode 112a, flows through the infrared electrothermal sub-coating A1 and the infrared electrothermal sub-coating A2 sequentially, and then flows out from the conductive electrode 112b.

It should be noted that, adding the conductive electrode 112c to heat the aerosol-forming substrate in a segmented manner in FIG. 7 is also applicable to the heaters in FIG. 3 and FIG. 4 and FIG. 8. It may be understood that, heating in a plurality of segments may be implemented through a plurality of conductive electrodes.

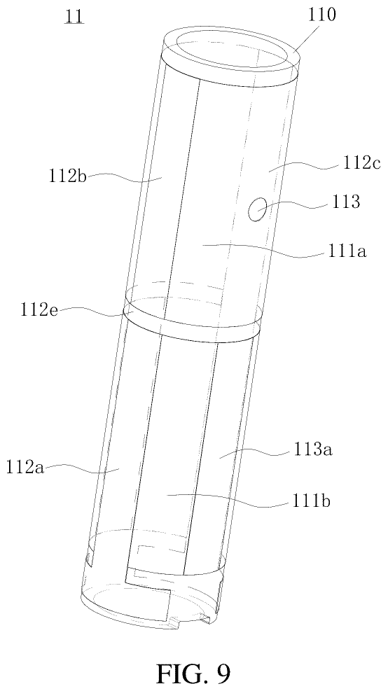

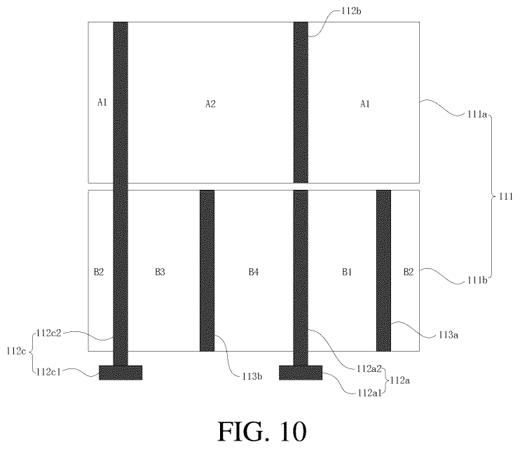

FIG. 9 and FIG. 10 show a fifth heater according to an implementation of this application.

Different from FIG. 3 and FIG. 4, the infrared electrothermal coating 111 includes two infrared electrothermal coatings spaced apart from each other, as shown by an infrared electrothermal coating 111a and an infrared electrothermal coating 111b shown in the figure. The infrared electrothermal coating 111a is closer to a nozzle end of the aerosol generating device 100 relative to the infrared electrothermal coating 111b. A spacing distance between the infrared electrothermal coating 111a and the infrared electrothermal coating 111b ranges from 0.2 mm to 1 mm.

The conductive electrode 112a includes a coupling portion 112a1 extending in the circumferential direction of the base body 110 and a conductive portion 112a2 extending in the axial direction from the coupling portion 112a1 toward the upper end of the base body 110. The coupling portion 112a1 is arc-shaped, the coupling portion 112a1 is spaced apart from the infrared electrothermal coating 111b, and the coupling portion 112a1 is arranged between the infrared electrothermal coating 111b and the lower end of the base body 110; and a wire may be welded on the coupling portion 112a1, to form an electrical connection with a power supply outside the heater 11, for example, the battery core 7 or a voltage converted by the battery core 7, or to form an electrical connection with the power supply through another electrical connector. The conductive portion 112a2 is strip-shaped, an extension length of the conductive portion in the axial direction is greater than an extension length of the infrared electrothermal coating 111b in the axial direction, and an upper end of the conductive portion 112a2 is flush with an upper end of the infrared electrothermal coating 111b; and the conductive portion 112a2 remains in contact with the infrared electrothermal coating 111b to form an electrical connection.

The conductive electrode 112b is strip-shaped, and an extension length of the conductive electrode in the axial direction is the same as an extension length of the infrared electrothermal coating 111a in the axial direction. The conductive electrode 112b remains in contact with the infrared electrothermal coating 111a to form an electrical connection.

A structure of the conductive electrode 112c is similar to that of the conductive electrode 112a. A coupling portion 112cl of the conductive electrode 112c is arranged between the infrared electrothermal coating 111b and the lower end of the base body 110, a conductive portion 112c2 is strip-shaped, but an extension length of the conductive portion in the axial direction is greater than a sum of the extension length of the infrared electrothermal coating 111a in the axial direction and the extension length of the infrared electrothermal coating 111b in the axial direction, and an upper end of the conductive portion 112c2 is flush with an upper end of the infrared electrothermal coating 111a. The conductive portion 112c2 remains in contact with the infrared electrothermal coating 111a and the infrared electrothermal coating 111b to form an electrical connection.

The connecting electrode 113a and the connecting electrode 113b are strip-shaped and are arranged in the infrared electrothermal coating 111b. Extension lengths of the connecting electrode 113a and the connecting electrode 113b in the axial direction are the same as the extension length of the infrared electrothermal coating 111b in the axial direction.

The connecting electrode 113a is arranged between the conductive electrode 112a and the conductive electrode 112c. The connecting electrode 113a divides the infrared electrothermal coating between the conductive electrode 112a and the conductive electrode 112c into two infrared electrothermal sub-coatings (as shown by B1 and B2 in FIG. 10) connected in series between the conductive electrode 112a and the conductive electrode 112c, and the infrared electrothermal sub-coating B1 and the infrared electrothermal sub-coating B2 are distributed in the circumferential direction of the base body 110; and an equivalent resistance of the infrared electrothermal sub-coating B1 and an equivalent resistance of the infrared electrothermal sub-coating B2 may be the same or may be different.

The connecting electrode 113b is also arranged between the conductive electrode 112a and the conductive electrode 112c. The connecting electrode 113b divides the infrared electrothermal coating between the conductive electrode 112a and the conductive electrode 112c into two infrared electrothermal sub-coatings (as shown by B3 and B4 in FIG. 10) connected in series between the conductive electrode 112a and the conductive electrode 112c, and the infrared electrothermal sub-coating B3 and the infrared electrothermal sub-coating B4 are distributed in the circumferential direction of the base body 110; and an equivalent resistance of the infrared electrothermal sub-coating B3 and an equivalent resistance of the infrared electrothermal sub-coating B4 may be the same or may be different.

Through the arrangement of the connecting electrode 113a and the connecting electrode 113b, an overall resistance of the infrared electrothermal coating 111b may be reduced.

Similar to FIG. 7 or FIG. 8, through the arrangement of the conductive element in FIG. 9, the infrared electrothermal coating 111a and the infrared electrothermal coating 111b may be independently controlled. Specifically, a power supply may be controlled to provide heating power to the infrared electrothermal coating 111a and/or the infrared electrothermal coating 111b. For example, the power supply is first controlled to provide heating power to the infrared electrothermal coating 111a to heat an upper half part (a part corresponding to a region of the infrared electrothermal coating 111a) of an aerosol generating article; and the power supply is then controlled to provide heating power to the infrared electrothermal coating 111b to heat a lower half part (a part corresponding to a region of the infrared electrothermal coating 111b) of the aerosol generating article; or vice versa.

Alternatively, the power supply is first controlled to provide heating power to the infrared electrothermal coating 111a to heat the upper half part of the aerosol generating article; and the power supply is then controlled to provide heating power to the infrared electrothermal coating 111a and the infrared electrothermal coating 111b simultaneously to heat the entire aerosol generating article.

Alternatively, the power supply is first controlled to provide heating power to the infrared electrothermal coating 111b to heat the lower half part of the aerosol generating article; and the power supply is then controlled to provide heating power to the infrared electrothermal coating 111a and the infrared electrothermal coating 111b simultaneously to heat the entire aerosol generating article.

When the infrared electrothermal coating 111a is controlled to perform heating, for example, the conductive electrode 112b is electrically connected to a positive electrode of the power supply, and the coupling portion 112cl is electrically connected to a negative electrode of the power supply. In this way, a current flows in from the conductive electrode 112b, flows through the infrared electrothermal sub-coating A1 or the infrared electrothermal sub-coating A2 in the circumferential direction of the base body 110, and flows out from the conductive portion 112c2.

When the infrared electrothermal coating 111b is controlled to perform heating, for example, the coupling portion 112a1 is electrically connected to the positive electrode of the power supply, the coupling portion 112cl is electrically connected to the negative electrode of the power supply, a current flows in from the conductive portion 112a2, flows through the infrared electrothermal sub-coating B1 and the infrared electrothermal sub-coating B2 sequentially or flows through the infrared electrothermal sub-coating B4 and the infrared electrothermal sub-coating B3 sequentially, and flows out from the conductive portion 112c2. The connecting electrode 113a and the connecting electrode 113b are not connected to a power supply or a circuit outside the heater 11. That is, the connecting electrode 113a and the connecting electrode 113b are suspended, and the current cannot directly flow in from the connecting electrode 113a and then flow out from the conductive portion 112b2 or the conductive portion 112a2. Due to the existence of the connecting electrode 113a and the connecting electrode 113b, the overall resistance of the infrared electrothermal coating 111b may be reduced.

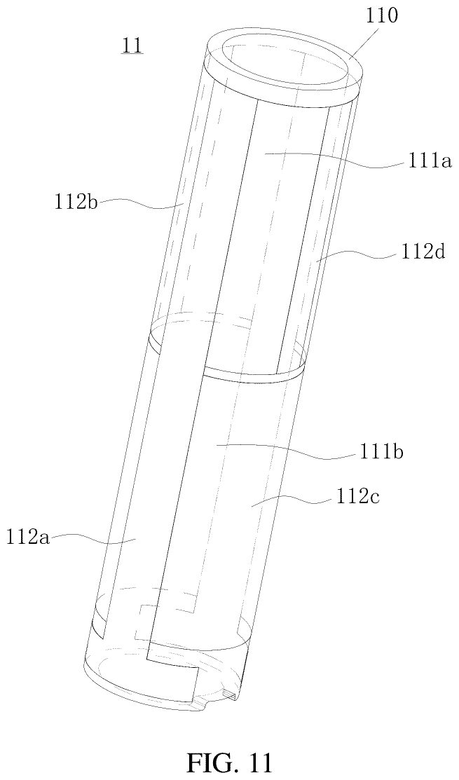

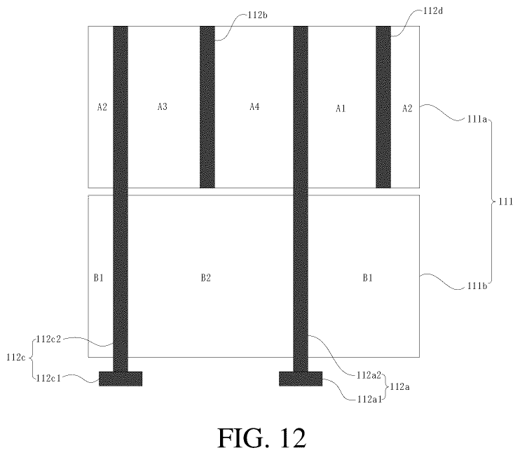

FIG. 11 and FIG. 12 show a sixth heater according to an implementation of this application.

Different from FIG. 9 and FIG. 10, an extension length of the conductive portion 112a2 of the conductive electrode 112a in the axial direction is greater than the sum of the extension length of the infrared electrothermal coating 111a in the axial direction and the extension length of the infrared electrothermal coating 111b in the axial direction, and the upper end of the conductive portion 112a2 is flush with the upper end of the infrared electrothermal coating 111a. The conductive portion 112a2 remains in contact with the infrared electrothermal coating 111a and the infrared electrothermal coating 111b to form an electrical connection. The conductive electrode 112b and a conductive electrode 112d are arranged in the region of the infrared electrothermal coating 111a, and remain in contact with the infrared electrothermal coating 111a to form an electrical connection. The conductive electrode 112b, the conductive portion 112a2, the conductive electrode 112d, and the conductive portion 112c2 are arranged at intervals sequentially in the circumferential direction of the base body 110.

Different from FIG. 9 and FIG. 10, the infrared electrothermal coating 111a may be controlled independently, and the infrared electrothermal coating 111b cannot be controlled independently.

When the heater 11 is controlled to perform heating, a power supply is first controlled through the conductive electrode 112b and the conductive electrode 112d to provide heating power to the infrared electrothermal coating 111a; and the power supply is then controlled through the conductive electrode 112a and the conductive electrode 112c to provide heating power to the infrared electrothermal coating 111a and the infrared electrothermal coating 111b simultaneously.

When the conductive electrode 112b and the conductive electrode 112d are powered on, a conductive portion (the conductive portion 112a2 of the conductive electrode 112a and the conductive portion 112c2 of the conductive electrode 112c) between the conductive electrode 112b and the conductive electrode 112d are not powered on, and the conductive portion is equivalent to the connecting electrode in the example of FIG. 9 and FIG. 10. Therefore, the overall resistance of the infrared electrothermal coating 111a is reduced, so that a temperature of the infrared electrothermal coating 111a is increased rapidly, and the upper half part of the aerosol generating article can be heated rapidly, achieving an objective of producing aerosols rapidly.

When the conductive electrode 112a and the conductive electrode 112c are powered on, the conductive electrode 112b and the conductive electrode 112d between the conductive electrode 112a and the conductive electrode 112c are not powered on, which are also equivalent to the connecting electrode in the example of FIG. 9 and FIG. 10, so that the overall resistance of the infrared electrothermal coating 111a is reduced. In this case, the infrared electrothermal coating 111a and the infrared electrothermal coating 111b perform heating simultaneously or the entire infrared electrothermal coating 111 performs heating, due to the existence of the conductive electrode 112b and the conductive electrode 112d, the overall resistance of the infrared electrothermal coating 111a is reduced, so that a temperature in the region of the infrared electrothermal coating 111a is improved, thereby changing a temperature field in the region of the entire infrared electrothermal coating 111.

It should be noted that, the specification of this application and the accompanying drawings thereof illustrate preferred embodiments of this application. However, this application may be implemented in various different forms, and is not limited to the embodiments described in this specification. These embodiments are not intended to be an additional limitation on the content of this application, and are described for the purpose of providing a more thorough and comprehensive understanding of the content disclosed in this application. Moreover, the above technical features may further be combined to form various embodiments not listed above, and all such embodiments shall be construed as falling within the scope of the specification of this application. Further, a person of ordinary skill in the art may make improvements and variations according to the above description, and such improvements and variations shall all fall within the protection scope of the appended claims of this application.

1. A heater comprising:
a base body;
an infrared electrothermal coating, arranged on a surface of the base body, wherein the infrared electrothermal coating is configured to generate an infrared ray radiantly heating an aerosol-forming substrate after the heater is powered on; and
a conductive element, comprising a first conductive electrode, a second conductive electrode, and at least one connecting electrode that are arranged at intervals on the surface of the base body, wherein
the at least one connecting electrode is configured to divide the infrared electrothermal coating into at least two infrared electrothermal sub-coatings connected in series between the first conductive electrode and the second conductive electrode; and
one of the first conductive electrode and the second conductive electrode is configured to receive an inflow of an external current, and the inflow current sequentially passes through the at least two infrared electrothermal sub-coatings connected in series and then flows out from the other of the first conductive electrode and the second conductive electrode.

2. The heater according to claim 1, wherein an equivalent resistance of any infrared electrothermal sub-coating is different from equivalent resistances of other infrared electrothermal sub-coating; or
an equivalent resistance of one infrared electrothermal sub-coating is the same as an equivalent resistance of at least one infrared electrothermal sub-coating in the other infrared electrothermal sub-coating.

3. The heater according to claim 1, wherein the connecting electrode is a consecutive conductive coating formed on the surface of the base body.

4. The heater according to claim 3, wherein a width of the connecting electrode ranges from 0.5 mm to 3 mm.

5. The heater according to claim 1, wherein the connecting electrode is a non-consecutive conductive coating formed on the surface of the base body.

6. The heater according to claim 1, wherein in a direction perpendicular to the surface of the base body, the connecting electrode is arranged between the base body and the infrared electrothermal coating; or the infrared electrothermal coating is arranged between the base body and the connecting electrode.

7. The heater according to claim 1, wherein the base body comprises a first end and a second end located upstream of the first end and opposite to the first end; and
the infrared electrothermal coating is spaced apart from the first end.

8. The heater according to claim 7, wherein a spacing distance between the infrared electrothermal coating and the first end ranges from 0.2 mm to 1 mm.

9. The heater according to claim 1, wherein the base body is constructed into a tube shape;
the at least two infrared electrothermal sub-coatings connected in series are distributed in a circumferential direction of the base body, and the connecting electrode is constructed into a strip-shaped electrode extending in an axial direction of the base body; or the at least two infrared electrothermal sub-coatings connected in series are distributed in the axial direction of the base body, and the connecting electrode is constructed into an annular electrode or an arc-shaped electrode extending in the circumferential direction of the base body; or the infrared electrothermal sub-coatings and the connecting electrode spirally extend in the axial direction of the base body.

10. The heater according to claim 1, wherein the base body is constructed into a tube shape;
an extension length of the connecting electrode in an axial direction of the base body is the same as an extension length of the infrared electrothermal coating in the axial direction of the base body; or an extension length of the connecting electrode in a circumferential direction of the base body is the same as an extension length of the infrared electrothermal coating in the circumferential direction of the base body; or an spiral extension height of the connecting electrode in the axial direction of the base body is the same as the extension length of the infrared electrothermal coating in the axial direction of the base body.

11. The heater according to claim 1, wherein the conductive element further comprises a third conductive electrode arranged on the surface of the base body, and the first conductive electrode, the second conductive electrode, and the third conductive electrode divide the infrared electrothermal coating into at least two independent heating regions;
the at least one connecting electrode is configured to divide the at least two independent heating regions into at least two first infrared electrothermal sub-coatings connected in series between the first conductive electrode and the third conductive electrode; and one of the first conductive electrode and the third conductive electrode is configured to receive an inflow of an external current, and the inflow current sequentially passes through the at least two first infrared electrothermal sub-coatings connected in series and then flows out from the other of the first conductive electrode and the third conductive electrode; and/or
the at least one connecting electrode is configured to divide the at least two independent heating regions into at least two second infrared electrothermal sub-coatings connected in series between the second conductive electrode and the third conductive electrode; and one of the second conductive electrode and the third conductive electrode is configured to receive an inflow of an external current, and the inflow current sequentially passes through the at least two second infrared electrothermal sub-coatings connected in series and then flows out from the other of the second conductive electrode and the third conductive electrode.

12. The heater according to claim 1, wherein the infrared electrothermal coating comprises a first infrared electrothermal coating and a second infrared electrothermal coating spaced apart from each other on the surface of the base body;
the at least one connecting electrode comprises a first connecting electrode and a second connecting electrode; the first connecting electrode and the second connecting electrode remain in contact with the first infrared electrothermal coating to form an electrical connection;
the first conductive electrode and the second conductive electrode remain in contact with the first infrared electrothermal coating to form an electrical connection, and the first conductive electrode and the second conductive electrode also remain in contact with the second infrared electrothermal coating to form an electrical connection; and
the first connecting electrode, the first conductive electrode, the second connecting electrode, and the second conductive electrode are arranged at intervals in a circumferential direction of the base body, wherein
one of the first connecting electrode and the second connecting electrode is configured to receive an inflow of an external current, and the current flows out from the other of the first connecting electrode and the second connecting electrode; or one of the first conductive electrode and the second conductive electrode is configured to receive an inflow of an external current, and the current flows out from the other of the first conductive electrode and the second conductive electrode.

13. The heater according to claim 1, wherein the base body is constructed into a tube shape, and an inner diameter of the tubular base body ranges from 7 mm to 14 mm; and
an extension length of the infrared electrothermal coating in an axial direction of the base body ranges from 5 mm to 40 mm.

14. An aerosol generating device, comprising a power supply configured to supply power and the heater according to claim 1.

15. The heater according to claim 1, wherein:
the base body has a first end and a second end opposite to each other, the first end has a first end edge and the second end has a second end edge;
the connecting electrode is a conductive coating formed on the surface of the base body;
the conductive coating has a first coating edge and a second coat edge;
the first coating edge is an edge of the infrared coating layer that is closest to the first end;
the second coating edge is an edge of the conductive coating that is closest to the second end; and
a first area located between the first coating edge and the first end edge, along a lengthwise direction of the heating base, is not coated with the conductive coating, or a second area located between the second coating edge and the second end edge, along the lengthwise direction of the heating base, is not coated with the conductive coating.

16. The heater according to claim 1, wherein:
the base body has a first end and a second end opposite to each other, the first end has a first end edge and the second end has a second end edge;
the infrared electrothermal coating has a third coating edge and a fourth coating edge;
the third coating edge is an edge of the infrared electrothermal coating that is closest to the first end;
the fourth coating edge is an edge of the infrared electrothermal coating that is closest to the second end; and
a third area located between the third coating edge and the first end edge, along a lengthwise direction of the heating base, is not coated with the infrared electrothermal coating; or a second area located between the fourth coating edge and the second end edge, along the lengthwise direction of the heating base, is not coated with the infrared electrothermal coating.
